(19) United States
(12) Patent Application Publication
(10) Pub. No.: US 2007/0132330 A1
(43) Pub. Date: Jun. 14, 2007

(54) Fan assemblies employing LSPM motors and LSPM motors having improved synchronization

(76) Inventors: Renyan William Fei, Qingdao (CN); Huazhan Michael Xu, Qingdao (CN)

Correspondence Address: HARNESS, DICKEY, & PIERCE, P.L.C, 7700 BONHOMME, STE 400, ST. LOUIS, MO, 63105, US

(21) Appl. No.: 11/299,602

(22) Filed: Dec. 12, 2005

(51) Int. Cl. H02K 21/12

(52) U.S. Cl. 310/156.78; 310/261

(57) ABSTRACT

A fan assembly includes at least one fan blade for moving air and a line-start permanent magnet (LSPM) motor having a shaft. The fan blade is coupled to the shaft of the line-start permanent magnet motor such that rotation of the shaft causes rotation of the fan blade for moving air. Also disclosed is an LSPM motor that includes a shaft and a squirrel cage rotor having a plurality of embedded magnets. The LSPM is configured to permit limited rotation of the squirrel cage rotor relative to the shaft as a speed of the motor approaches a synchronous speed. This LSPM motor can be used in a variety of applications including, without limitation, fan assemblies, fluid pumps, etc.

### FIELD OF THE INVENTION

The present invention relates generally to fan assemblies employing line-start permanent magnet (LSPM) motors, and LSPM motors that more readily achieve synchronous speeds, including when the motors are coupled to loads.

### BACKGROUND OF THE INVENTION

Various types of fan assemblies are known in the art for moving air including, for example, condenser fans for air conditioning systems, oscillating and non-oscillating fans for comfort or exhaust purposes, etc. Many of these fan assemblies have conventionally employed induction motors for driving rotation of fan blades to move air. More recently, permanent magnet motors and, in particular, brushless DC (BLDC) motors, have been incorporated into fan assemblies. BLDC motors are generally more efficient and less noisy than comparable induction motors. These BLDC motors require electronic variable frequency controllers to control energization of the BLDC motors.

As recognized by the present inventor, the controllers for BLDC motors are expensive and increase the overall cost of fan assemblies in which they are used. The present inventor has therefore recognized a need for an alternative to BLDC motors for use in fan assemblies.

### SUMMARY OF THE INVENTION

In order to solve these and other needs in the art, the present inventor has designed fan assemblies which employ line-start permanent magnet (LSPM) motors. LSPM motors do not require expensive electronic controllers, and are generally more efficient than comparable induction motors. Additionally, the present inventor has designed LSPM motors that more readily achieve synchronous speed, including when the motor is coupled to a load. These improved LSPM motors can be used in a variety of applications including fan assemblies, fluid pumps, etc.

According to one aspect of the present invention, a fan assembly includes at least one fan blade for moving air and a line-start permanent magnet motor having a shaft. The fan blade is coupled to the shaft of the line-start permanent magnet motor such that rotation of the shaft causes rotation of the fan blade for moving air.

According to another aspect of the present invention, a line-start permanent magnet (LSPM) motor includes a shaft and a squirrel cage rotor having a plurality of embedded magnets. The LSPM motor is configured to permit limited rotation of the squirrel cage rotor relative to the shaft as a speed of the motor approaches a synchronous speed.

According to yet another aspect of the invention, a line-start permanent magnet (LSPM) motor includes a shaft, a rotor assembly including a squirrel cage rotor having a plurality of embedded permanent magnets, and a coupling finger extending from the shaft and positioned within a notch defined by the rotor assembly to allow limited rotation of the rotor assembly relative to the shaft as the LSPM motor approaches a synchronous speed.

Further aspects of the present invention will be in part apparent and in part pointed out below. It should be understood that various aspects of the invention may be implemented individually or in combination with one another. It should also be understood that the detailed description and drawings, while indicating certain exemplary embodiments of the invention, are intended for purposes of illustration only and should not be construed as limiting the scope of the invention.

### BRIEF DESCRIPTION OF THE DRAWINGS

FIG. 1 is a block diagram of a fan assembly having an LSPM motor according to one exemplary embodiment of the present invention.

FIG. 2 is a cross-sectional end view of an LSPM motor configured to permit limited rotation of a rotor assembly relative to a shaft according to another exemplary embodiment of the present invention.

FIG. 3 is a cross-sectional side view of an alternative rotor and shaft assembly for the LSPM motor of FIG. 2.

FIG. 4 is a cross-sectional end view taken along line A-A of FIG. 3.

FIG. 5 is a connection diagram for an LSPM motor according to another embodiment of the invention.

FIG. 6 is an alternative connection diagram for an LSPM motor according to still another embodiment of the invention.

Like reference symbols indicate like elements or features throughout the drawings.

### DETAILED DESCRIPTION OF SPECIFIC EMBODIMENTS

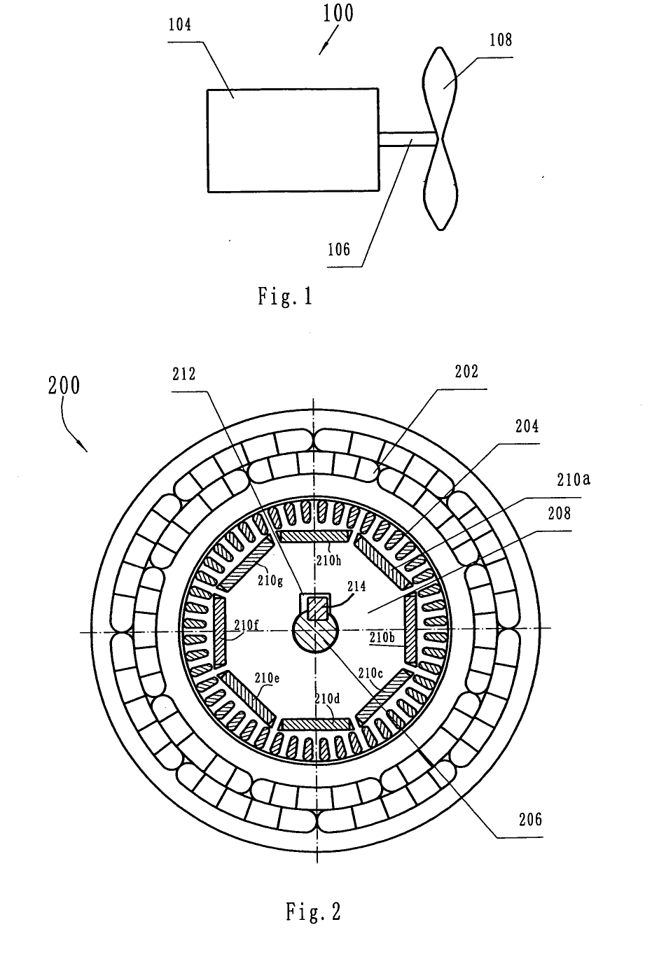

A fan assembly according to a first embodiment of the present invention is shown in FIG. 1 and indicated generally by reference number 100. As shown in FIG. 1, the fan assembly 100 includes an LSPM motor 104. The LSPM motor 104 is employed in lieu of, for example, an induction motor or a BLDC motor. The LSPM motor 104 is generally more efficient and quieter at synchronous speed than a comparable induction motor. Therefore, the performance of the fan assembly 100 is improved as compared to known fan assemblies employing induction motors, but without requiring the expensive electronic variable frequency controller commonly used with BLDC motors. As shown in FIG. 1, the LSPM motor 104 includes a shaft 106 coupled to one or more fan blades 108 for driving rotation of the fan blades 108 to move air.

The fan assembly 100 of FIG. 1 can be used in a variety of applications. For example, the fan assembly 100 can be embodied in a condenser fan assembly for an air conditioning system. Indeed, the cost, efficiency and low noise level of the LSPM motor 104 renders the fan assembly 100 particularly well suited for residential and commercial air conditioning systems, where unit costs and operating costs are important. Alternatively, the fan assembly 100 can be employed in other applications such as, for example, oscillating and non-oscillating fans for comfort or exhaust purposes. As apparent to those skilled in the art, the LSPM motor 104 of FIG. 1 is configured to rotate the shaft 106 in only a single direction.

In some preferred embodiments, the LSPM motor 104 is an eight pole motor. However, LSPM motors have more or less than eight poles can also be employed. Further, the LSPM motor 104 can employ a single-phase or multi-phase (e.g., 3-phase) design.

In certain applications and under certain conditions, an LSPM motor can have difficulty achieving synchronous speed, particularly when a load is coupled to the motor shaft during starting. To address this issue, an LSPM motor according to another embodiment of the present invention includes a shaft and a squirrel cage rotor having several embedded permanent magnets. The LSPM motor is configured to permit limited rotation of the squirrel cage rotor relative to the shaft as a speed of the motor approaches a synchronous speed. As further explained below, permitting limited rotation of the rotor relative to the shaft assists the LSPM motor in achieving synchronization, including when a load is coupled to the shaft. Two specific constructions of such an LSPM motor will now be described with reference to FIGS. 2-4. It should be understood, however, that other constructions can be employed for permitting limited rotation of a rotor relative to a shaft in an LSPM motor.

FIG. 2 illustrates an LSPM motor 200 having a stator 202, a rotor assembly 204, and a shaft 206. The rotor assembly 204 includes a squirrel cage rotor 208 and eight permanent magnets 210a-h embedded in the rotor 208 so as to define eight poles. It should be understood, however, that a different number of magnets/poles (e.g., 2-pole, 4-pole, 6-pole, etc.) can be employed without departing from the scope of the present invention.

As shown in FIG. 2, the rotor assembly 204 is coupled to the shaft 206 so as to permit limited rotation of the rotor assembly 204 relative to the shaft 206. Specifically, the rotor assembly defines a notch 212. A coupling finger 214 projects from the shaft 206 and is positioned within the notch 212. The coupling finger 214 can be fixedly coupled to the shaft 206 or formed integrally with the shaft 206. The notch 212 is larger than the coupling finger 214 such that extra space exists within the notch 212. The rotor assembly 204 is therefore allowed to rotate a limited distance in the clockwise and counterclockwise directions until either side of the notch 212 engages the coupling finger 214. This limited ability of the rotor assembly 204 to rotate relative to the shaft 206 assists the LSPM motor 200 in reaching its synchronous speed, as further explained below.

Rather than fixedly coupling the rotor assembly 204 to the shaft 206 in a conventional manner, a slippery interface is provided between the rotor assembly 204 and the shaft 206 so as to permit the rotor to rotate freely relative to the shaft 206, except as limited by interaction between the notch 212 and the coupling finger 214.

When the LSPM motor 200 is energized with the coupling finger 214 generally centered within the notch 212, the rotor assembly 204 is essentially starting under a no-load condition. Once the rotor assembly 204 has rotated a limited distance such that one side of the notch 212 engages the finger 214, the motor may have already established its synchronous torque. In that event, the motor has achieved its synchronous torque which may pull the shaft 206, and any load coupled to the shaft 206, up to synchronous speed within a short time period. If the synchronous torque is insufficient to pull the shaft 206 and load up to synchronous speed quickly, the motor will run at an asynchronous speed that is lower than the synchronous speed. In this case, the torque provided by the permanent magnets 210a-h is pulsating. This pulsating torque causes the rotor assembly 204 to vibrate back and forth on the shaft 206, typically beginning at about 80% of the synchronous speed, to the extent permitted by the notch 212 and the coupling finger 214. This back and forth vibration will last only a short period of time, until the rotor assembly 204 is pulled up to synchronous speed. Once the rotor assembly 204 is synchronized, the synchronous torque is established. Shortly thereafter, one side of the notch 212 will engage the coupling finger 214 and the synchronous torque will pull the shaft 206 and load up to synchronous speed.

In other words, because the rotor assembly 204 is permitted to rotate a limited distance relative to the shaft 206, the rotor assembly 204 can be synchronized during a short essentially no-load condition, or synchronized shortly after vibrating back and forth about the shaft 206 in response to the pulsating asynchronous torque. Therefore, as compared to a rotor fixedly coupled to the shaft 206, the LSPM motor 200 of this embodiment can be synchronized more readily. Similarly, if the LSPM motor 200 loses synchronization for some reason, the limited ability of the rotor to rotate relative to the shaft 206 will assist the motor in pulling the rotor assembly 204, the shaft 206 and the load back to synchronization.

As just one example, a single-phase LSPM motor having a rotor fixedly coupled to the shaft was unable to synchronize at 250 volts, while a comparable LSPM motor constructed according to the present embodiment (and having the same load coupled to the shaft) achieved synchronous speed at only 187 volts.

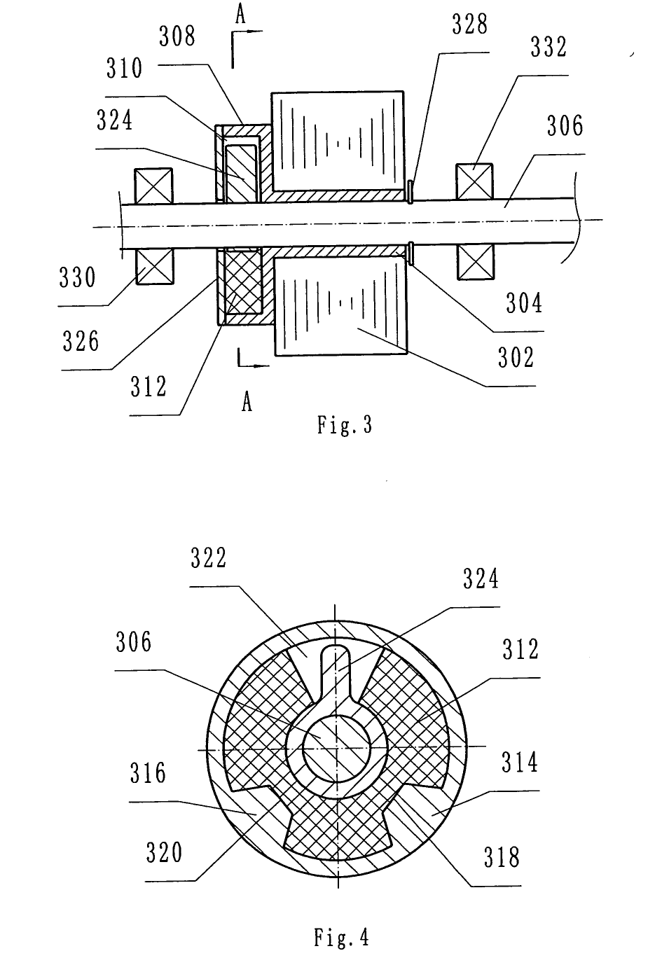

FIGS. 3 and 4 illustrate an alternative rotor and shaft assembly for the LSPM motor 200 of FIG. 2. As shown in FIG. 3, a rotor 302 is fixedly coupled to a sleeve 304, such as by press-fitting the rotor onto the sleeve 304. The sleeve 304 is mounted about a shaft 306 so as to permit the shaft 306 to rotate freely within the sleeve 304. One end of the sleeve 304 includes a circular flange 308 that defines a cavity 310. As best shown in FIG. 4, a buffer 312 is positioned in the flange cavity 310. Two portions 314, 316 of the flange 308 extend radially inwardly and engage complementary portions 318, 320 of the buffer 312 to retain the buffer 312 in a generally fixed position. The buffer 312 occupies only a portion of the flange cavity 310 so as to define a notch 322 in the flange cavity 310. A coupling finger 324 is fixedly coupled to the shaft 306 and extends into the notch 322. Similar to the embodiment of FIG. 2, the notch 322 is larger than the portion of the coupling finger 324 positioned therein such that extra space exists in the notch 322. This space allows the rotor assembly to rotate or vibrate a limited distance in the clockwise and counterclockwise directions until either side of the notch 322 engages the coupling finger 324. As explained above with reference to FIG. 2, this ability of the rotor assembly to rotate a limited distance relative to the shaft 306 assists the motor in achieving synchronization.

In the embodiment of FIGS. 3 and 4, the notch 322 spans about sixty mechanical degrees, and the width of the coupling finger 324 is about fifteen mechanical degrees. Therefore, the coupling finger 324 is allowed to rotate or vibrate back and forth through an angle up to about forty-five mechanical degrees relative to the shaft 306. It should be understood, however, that the permitted amount of rotation of the coupling finger 324 relative to the shaft 306 can be adjusted as necessary for any given application of the invention.

Referring again to FIG. 3, a spring retainer 328 is provided on one end of the shaft 306. The spring retainer 328 and the coupling finger 324 control the axial location of the rotor 302 on the shaft 306 (between bearings 330, 332, in the embodiment of FIG. 3). The sleeve 304 can be formed of brass, powder metal, or other suitable material. The buffer 312 can be formed of a flexible material, such as rubber or plastic, or another suitable material. Additionally, a cover 326 is coupled to the circular flange 308 to protect the coupling finger 324 positioned in the flange cavity 310.

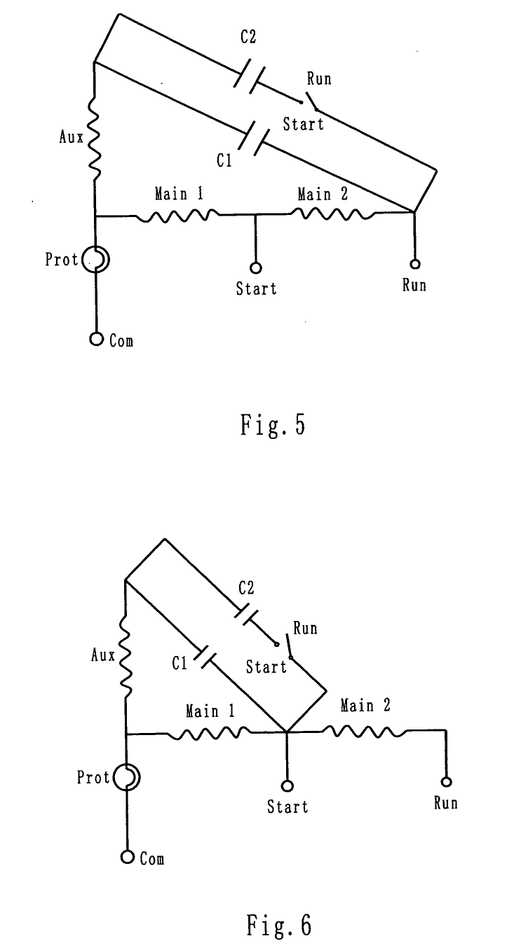

The LSPM motor 200 described above with reference to FIGS. 2-4 can be started and synchronized using either one of the connection diagrams shown in FIGS. 5 and 6. The connection diagram of FIG. 5 is similar to an L-connection. The connection diagram of FIG. 6 is similar to a T-connection. In both connection diagrams, an additional capacitor C2 is employed during starting to increase the induction torque. The additional capacitor C2 is removed from the circuit during running for improved efficiency. By employing the connection diagram of FIG. 5 or 6, the cusp caused by the permanent magnets 210a-h (before the half speed) is readily overcome. Although FIGS. 5 and 6 illustrate connection diagrams for a single-phase LSPM motor, it should be understood that the teachings of the present invention are also applicable to three-phase LSPM motors.

As should be apparent, the LSPM motor 200 described above with reference to FIGS. 2-4 can be used in a wide variety of applications. For example, the LSPM motor 200 can be used in the fan assembly 100 of FIG. 1 (i.e., in place of the LSPM motor 102). The LSPM motor 200 can also be used in other types of fan assemblies including, without limitation, oscillating and non-oscillating fan assemblies. Further, the LSPM motor 200 can be used in other applications including fluid pump applications as well as virtually any other single-phase or poly-phase application where inductions motors have been employed.

Those skilled in the art will recognize that various changes can be made to the exemplary embodiments and implementations described above without departing from the scope of the present invention. Accordingly, all matter contained in the above description or shown in the accompanying drawings should be interpreted as illustrative and not in a limiting sense.

What is claimed is:

1. A fan assembly comprising at least one fan blade for moving air and a line-start permanent magnet motor having a shaft and a rotor assembly, the at least one fan blade being coupled to the shaft of the line-start permanent magnet motor such that rotation of the shaft causes rotation of the at least one fan blade for moving air, the motor being configured to permit limited rotation of the rotor assembly relative to the shaft as a speed of the motor approaches a synchronous speed.

3. The fan assembly of claim 1 wherein the rotor assembly defines a notch therein, the shaft includes a coupling finger projecting therefrom, and the coupling finger is positioned within the notch.

4. The fan assembly of claim 1 wherein the motor is a single phase motor.

5. The fan assembly of claim 1 wherein the motor is configured to rotate the shaft in only a single direction.

6. The fan assembly of claim 5 wherein the fan assembly is a condenser fan assembly for an air conditioning system.

7. The fan assembly of claim 1 wherein the motor is an eight pole motor.

8. A line-start permanent magnet (LSPM) motor comprising a shaft and a squirrel cage rotor having a plurality of embedded magnets, the motor being configured to permit limited rotation of the squirrel cage rotor relative to the shaft as a speed of the motor approaches a synchronous speed.

9. The LSPM motor of claim 8 wherein the rotor defines a notch therein and the shaft includes a coupling finger projecting therefrom and positioned within the notch.

10. The LSPM motor of claim 8 wherein the motor is configured to permit the rotor to rotate through an angle up to about 45 degrees relative to the shaft as the speed of the motor approaches the synchronous speed.

11. The LSPM motor of claim 8 wherein the motor is configured to rotate the shaft in only one direction.

12. The LSPM motor of claim 8 wherein the motor is a single phase motor.

13. The LSPM motor of claim 8 wherein the motor is an eight pole motor.

14. A fan assembly comprising the LSPM motor of claim 8.

15. A line-start permanent magnet (LSPM) motor comprising a shaft, a rotor assembly including a squirrel cage rotor having a plurality of embedded permanent magnets, and a coupling finger extending from the shaft and positioned within a notch defined by the rotor assembly to allow limited rotation of the rotor assembly relative to the shaft as the LSPM motor approaches a synchronous speed.

16. The LSPM motor of claim 15 wherein the rotor assembly further includes a buffer defining said notch.

17. The LSPM motor of claim 16 wherein the rotor assembly further includes a sleeve fixedly coupled to the rotor.

18. The LSPM motor of claim 17 wherein the buffer is positioned within a portion of the sleeve.

19. The LSPM motor of claim 18 wherein the sleeve is coupled to the shaft so as to permit rotation of the shaft relative to the sleeve.

20. The LSPM motor of claim 18 wherein the buffer comprises a flexible material.

21. The LSPM motor of claim 15 wherein the coupling finger is fixed coupled to the shaft.

22. A fan assembly comprising the LSPM motor of claim 15.
